(19) United States
(12) Patent Application Publication
(10) Pub. No.: US 2014/0175931 A1
(43) Pub. Date: Jun. 26, 2014

(54) AXIAL FLUX PERMANENT MAGNET MOTOR

(71) Applicant: SAMSUNG ELECTRO-MECHANICS CO., LTD., Suwon (KR)

(72) Inventors: Sang Jong LEE, Suwon (KR); Han Kyung BAE, Suwon (KR); Hee Soo YOON, Suwon (KR); Sung Jun LEEM, Suwon (KR)

(73) Assignee: SAMSUNG ELECTRO-MECHANICS CO., LTD., Suwon (KR)

(21) Appl. No.: 13/780,661

(22) Filed: Feb. 28, 2013

(30) Foreign Application Priority Data
Dec. 21, 2012 (KR) 10-2012-0150520

(51) Int. Cl. H02K 1/27

(52) U.S. Cl. CPC H02K 1/2793
USPC 310/156.32

(57) ABSTRACT

An axial flux permanent magnet motor includes a shaft, a rotor extending from the shaft in a radial direction, the rotor being rotatably mounted on the shaft, a magnet part disposed on the rotor to face downwardly in an axial direction, the magnet part having N poles and S poles, alternately disposed in a circumferential direction, a support member extending from the shaft in a radial direction, the support member being disposed below the rotor in the axial direction, and an electromagnet part disposed on the support member to face the magnet part in the axial direction. An axial distance between facing surfaces of the magnet part and the electromagnet part repeatedly changes in the circumferential direction.

### CROSS-REFERENCE TO RELATED APPLICATIONS

This application claims the priority of Korean Patent Application No. 10-2012-0150520 filed on Dec. 21, 2012, in the Korean Intellectual Property Office, the disclosure of which is incorporated herein by reference.

### BACKGROUND OF THE INVENTION

1. Field of the Invention

The present invention relates to an axial flux permanent magnet motor.

2. Description of the Related Art

Axial flux permanent magnet motors are motors in which a permanent magnet part mounted on a rotor member and an electromagnet part mounted on a stator member interact with each other so that the rotor member rotates with respect to the stator member. Particularly, in such an axial flux permanent magnet motor, a permanent magnet part in which a plurality of permanent magnets are disposed in a circumferential direction and an electromagnet part in which a plurality of electromagnets are disposed in the circumferential direction are disposed to face each other in an axial direction.

In this case, the electromagnet of the electromagnet part is disposed to be spaced apart from an adjacent electromagnet by a predetermined distance. This may be equally applied to the permanent magnets of the permanent magnet part. Thus, a graph of a time-varying electromotive force variation that occurs through the interaction between the electromagnet part and the permanent magnet part has a trapezoidal shape as shown in FIG. 8.

This is done because of a feature of the arrangement between the electromagnet and the permanent magnet in which a distance between the electromagnet and the permanent magnet that face each other is maintained to be constant, and then the electromagnet and the permanent magnet are spaced apart from each other by a predetermined distance. That is, back electromotive force is maintained at a predetermined peak value in the portion in which the distance between the electromagnet and the permanent magnet is constantly maintained and then falls to zero in the portion in which the electromagnet and the permanent magnet are spaced apart from each other by a predetermined distance.

In the case that the back electromotive force variation graph as shown in FIG. 8 is formed, when the rotor member rotates relatively with respect to the stator member, the rotor member may not rotate smoothly, but may rotate sporadically.

### SUMMARY OF THE INVENTION

An aspect of the present invention provides an axial flux permanent magnet motor in which a rotor member rotates smoothly with respect to a stator member when the rotor member rotates relatively with respect to the stator member.

Another aspect of the present invention provides an axial flux permanent magnet motor having simple changes in configuration to solve the above-described limitations.

According to an aspect of the present invention, there is provided an axial flux permanent magnet motor including: a shaft; a rotor extending from the shaft in a radial direction, the rotor being rotatably mounted on the shaft; a magnet part disposed on the rotor to face downwardly in an axial direction, the magnet part having N poles and S poles, alternately disposed in a circumferential direction; a support member extending from the shaft in a radial direction, the support member being disposed below the rotor in the axial direction; and an electromagnet part disposed on the support member to face the magnet part in the axial direction, wherein an axial distance between facing surfaces of the magnet part and the electromagnet part repeatedly changes in the circumferential direction.

The magnet part may include a plurality of magnets provided in the circumferential direction, and each of the plurality of magnets may include both circumferential ends thereof tapered so that a circumferential central portion thereof protrudes downwardly in the axial direction.

The magnet part may include a plurality of magnets provided in the circumferential direction, and each of the plurality of magnets may be rounded in the circumferential direction so that a circumferential central portion thereof protrudes downwardly in the axial direction.

The electromagnet part may include a plurality of electromagnets provided in the circumferential direction, and each of the plurality of electromagnets may include both circumferential ends thereof tapered so that a circumferential central portion thereof protrudes upwardly in the axial direction.

The electromagnet part may include a plurality of electromagnets provided in the circumferential direction, and each of the plurality of electromagnets may be rounded in the circumferential so that a circumferential central portion thereof protrudes upwardly in the axial direction.

The electromagnet part may include a plurality of electromagnets disposed in the circumferential direction, wherein each of the plurality of electromagnets may include a core and a coil wound around the core, wherein an axial upper end of the core may face the magnet part.

The winding coil of the electromagnet part may be repeatedly disposed in the circumferential direction.

According to another aspect of the present invention, there is provided an axial flux permanent magnet motor including: a shaft; a rotor spaced apart from the shaft in an axial direction by a predetermined distance and including a pair of first and second extension members extending in a radial direction, the rotor being rotatably mounted on the shaft; first and second magnet parts respectively disposed on the first and second extension members to face each other in the axial direction, the first and second magnet parts having N poles and S poles, alternately disposed in a circumferential direction; a support member extending from the shaft in the radial direction, the support member being disposed between the first and second extension members in the axial direction; and an electromagnet part disposed on the support member to face the first and second magnet parts in the axial direction, wherein an axial distance between facing surfaces of the first and second magnet parts and the electromagnet part repeatedly changes in the circumferential direction.

The first and second extension members may be connected to each other at radial outer ends thereof.

Each of the first and second magnet parts may include a plurality of magnets, and each of the plurality of magnets may include both circumferential ends thereof tapered so that a circumferential central portion thereof protrudes toward the electromagnet in the axial direction.

Each of the first and second magnet parts may include a plurality of magnets, and each of the plurality of magnets may be rounded in the circumferential direction so that a circumferential central portion thereof protrudes toward the electromagnet in the axial direction.

The electromagnet part may include a plurality of electromagnets provided in the circumferential direction, and each of the plurality of electromagnets may include both circumferential ends thereof tapered so that a circumferential central portion thereof protrudes toward the first and second magnet parts in the axial direction.

The electromagnet part may include a plurality of electromagnets provided in the circumferential direction, and each of the plurality of electromagnets may be rounded in the circumferential direction so that a circumferential central portion thereof protrudes toward the first and second magnet parts in the axial direction.

The first magnet part may include a plurality of magnets provided in the circumferential direction, and each of the plurality of magnets may be rounded in the circumferential direction so that a circumferential central portion thereof protrudes toward the electromagnet part in the axial direction.

The electromagnet part may include a plurality of electromagnets provided in the circumferential direction, and each of the plurality of electromagnets may be rounded in the circumferential direction so that a circumferential central portion thereof protrudes toward the second magnet part in the axial direction.

The electromagnet part may include a plurality of electromagnets disposed in the circumferential direction, wherein each of the plurality of electromagnets may include a core and a coil wound around the core, wherein axial upper and lower ends of the core may face the first and second magnet parts, respectively.

The winding coil of the electromagnet part may be repeatedly disposed in the circumferential direction.

According to another aspect of the present invention, there is provided an axial flux permanent magnet motor including: a stator member; a rotor member rotatably mounted on the stator member; a magnet part disposed on the rotor member to face an axial direction, the magnet part having N poles and S poles, alternately disposed in a circumferential direction; and an electromagnet part disposed on the stator member to face the magnet part in the axial direction, wherein an axial distance between facing surfaces of the magnet part and the electromagnet part repeatedly changes in the circumferential direction.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view of an axial flux permanent magnet motor according to an embodiment of the present invention;

FIG. 2 is a plan view of a portion at which a magnet part and an electromagnet part which are used in the axial flux permanent magnet motor face each other according to an embodiment of the present invention;

FIG. 3 is a plan view of an electromagnet constituting the electromagnet part and a cross-sectional view of the electromagnet in a circumferential direction according to an embodiment of the present invention;

FIG. 4 is a plan view of a magnet constituting the magnet part and a cross-sectional view of the magnet part in the circumferential direction according to an embodiment of the present invention;

FIG. 5 is a cross-sectional view of an axial flux permanent magnet motor according to another embodiment of the present invention;

FIG. 6 is a plan view of an electromagnet constituting an electromagnet part and a cross-sectional view of the electromagnet in a circumferential direction according to another embodiment of the present invention;

FIG. 7 is a graph illustrating back electromotive force occurring when an axial flux permanent magnet motor operates according to the present invention; and

FIG. 8 is a graph illustrating back electromotive force occurring when an axial flux permanent magnet motor operates according to a related art.

### DETAILED DESCRIPTION OF THE PREFERRED EMBODIMENT

Exemplary embodiments of the present invention will now be described in detail with reference to the accompanying drawings. However, the spirit of the invention is not limited to the embodiment, but retrograde embodiments and other embodiments within the scope of the invention may be easily proposed by adding, changing or deleting any component.

Moreover, detailed descriptions related to well-known functions or configurations will be ruled out in order not to unnecessarily obscure subject matters of the present invention.

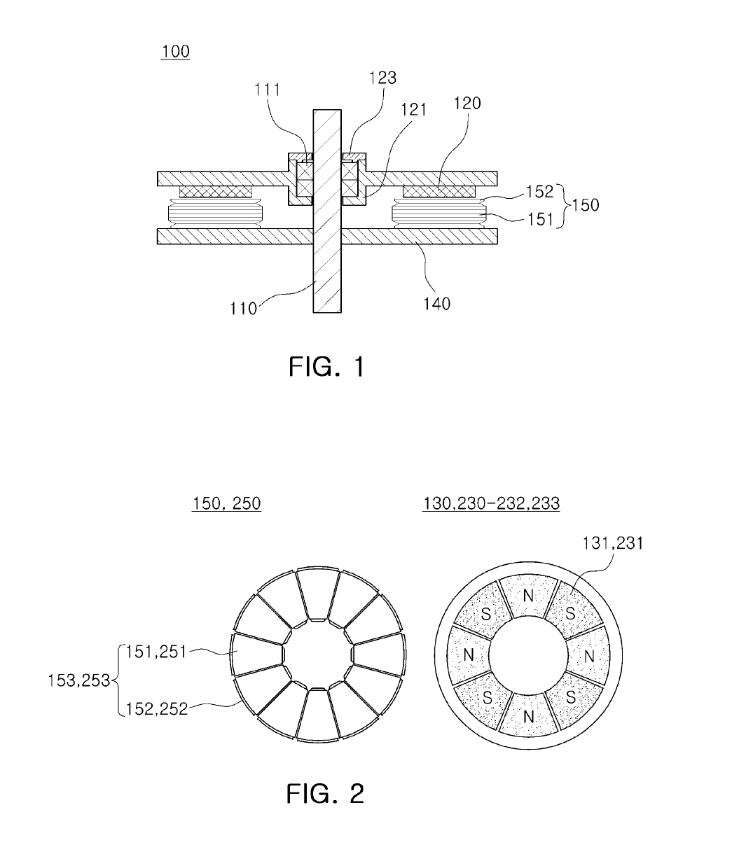

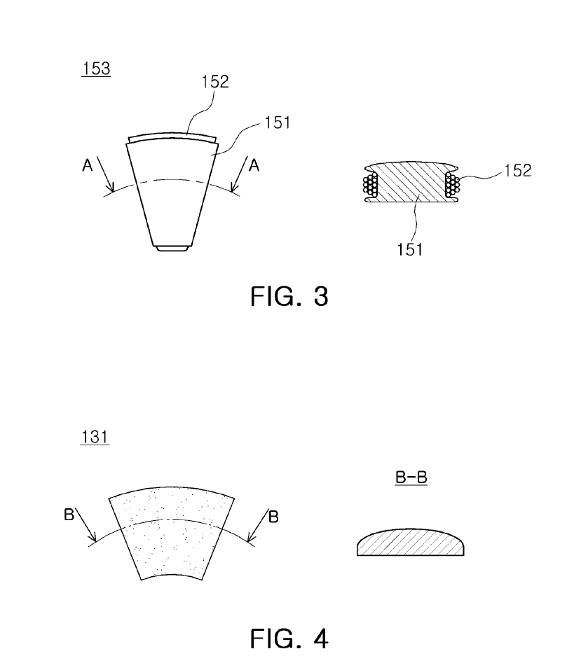

FIG. 1 is a cross-sectional view of an axial flux permanent magnet motor according to an embodiment of the present invention. FIG. 2 is a plan view of a portion at which a magnet part and an electromagnet part which are used in the axial flux permanent magnet motor face each other according to an embodiment of the present invention. FIG. 3 is a plan view of an electromagnet constituting the electromagnet part and a cross-sectional view of the electromagnet in a circumferential direction according to an embodiment of the present invention. FIG. 4 is a plan view of a magnet constituting the magnet part and a cross-sectional view of the magnet part in the circumferential direction according to an embodiment of the present invention.

Referring to FIG. 1, an axial flux permanent magnet motor 100 according to an embodiment of the present invention may include a shaft 110, a rotor 120, a magnet part 130, a support member 140, and an electromagnet part 150.

Here, terms with respect to directions will be defined. As shown in FIG. 1, an axial direction refers to a vertical direction, i.e., a direction upward from a lower portion of the shaft 110 or a direction downward from an upper portion of the shaft 110, and a radial direction refers to a horizontal direction, i.e., a direction toward an outer edge of the rotor 120 from the shaft 110 or a direction toward the shaft 110 from the outer edge of the rotor 120. Also, a circumferential direction refers to a direction of rotation along a predetermined radius with respect to a rotational center. For example, the circumferential direction may represent a direction rotating along the outer end of the rotor 120.

In the axial flux permanent magnet motor 100 according to an embodiment of the present invention, a rotor member may rotate relatively with respect to a stator member by using the magnet part 130 and the electromagnet part 150 which are disposed to face each other in an axial direction. In this case, the rotor member may smoothly rotate with respect to the stator member by configurations of the magnet part 130 and the electromagnet part 150.

Here, the rotor member may be a member that rotates relatively with respect to the stator member. Also, the rotor member may include the rotor 120 and the magnet part 130.

Furthermore, the stator member may be a member relatively fixed to the rotor member. Also, the stator member may include the shaft 110, the support member 140, and the electromagnet part 150.

The shaft 110 may be a member having a bar shape, disposed in the axial direction. The shaft 110 may have a round pillar shape so that a member mounted on the shaft 110 easily rotates.

A bearing part 111 may be disposed on an outer circumferential surface of the shaft 110. The bearing part 111 may be disposed on a portion at which a radial inner end of the rotor 120 is mounted on the shaft 110 so that the rotor 120 mounted on the shaft 110 rotates smoothly. The bearing part 111 may fix a rotating shaft of the rotor 120 to a predetermined position, i.e., the shaft 110. In addition, the bearing part 111 may rotate the shaft of the rotor 120 while supporting a self-weight of the shaft of the rotor 120 and a load applied to the shaft of the rotor 120. A sliding bearing or a rolling bearing may be used as the bearing part 111. For example, the sliding bearing may be lubricating oil disposed between the shaft 110 and the rotor 120. Also, the rolling bearing may be a ball bearing provided in the shaft 110. Hereinafter, the ball bearing will be described as one example of the bearing part 111.

The rotor 120 may be rotatably coupled to the shaft 110. That is, the rotor 120 may be coupled to the shaft 110 so that the rotor 120 rotates smoothly by using the bearing part 111 disposed on the shaft 110 as a medium. That is, the rotor 120 may extend outward from the shaft 110 in a radial direction. Also, the rotor 120 may be rotatably mounted on the shaft 110.

In more detail, a bearing fixing part 121 may be disposed on the radial inner end of the rotor 120. The bearing fixing part 121 may have a shape to accommodate the bearing part 111 disposed on a radial outer circumferential surface of the shaft 110. That is, the bearing fixing part 121 may be securely fixed by covering a fixing cap 123 on an upper portion thereof in the state in which the bearing fixing part 121 accommodates the bearing part 111 therein. The fixing cap 123 may be fixed to the bearing fixing part 121 through an inter-member coupling member such as press fitting, bonding using an adhesive, welding, and the like.

The magnet part 130 may be disposed on the rotor 120. In more detail, the magnet part 130 may be disposed on the rotor 120 so that a lower portion thereof is oriented in the axial direction. Here, N poles and S poles of the magnet part 130 may be alternately disposed in a circumferential direction. Also, the magnet part 130 may include a plurality of magnets 131 in the circumferential direction. That is, the magnet part 130 may include the plurality of magnets 131 in which the N poles and the S poles are alternately disposed in the circumferential direction.

Here, an axial distance between facing surfaces of the magnet part 130 and the electromagnet part 150 may repeatedly change in the circumferential direction. That is, each of the plurality of magnets 131 may have both circumferential ends that are tapered so that a circumferential central portion thereof protrudes downwardly in the axial direction, i.e., toward the electromagnet part 150. Also, each of the plurality of magnets 131 may be rounded in the circumferential direction so that the circumferential central portion thereof protrudes downwardly in the axial direction, i.e., toward the electromagnet part 150.

The support member 140 may extend outward from the shaft 110 in the radial direction. Also, the support member 140 may be disposed below the rotor 120 in the axial direction. The electromagnet part 150 may be disposed on an upper portion of the support member 140 in the axial direction to face the magnet part 130.

The electromagnet part 150 may be disposed on the support member 140. In more detail, the electromagnet part 150 may be disposed on the support member 140 to face an upper side in the axial direction. That is, the electromagnet part 150 may be disposed in the circumferential direction to face the magnet part 130. Also, the electromagnet part 150 may include a plurality of electromagnets 153 in the circumferential direction.

Here, the axial distance between the facing surfaces of the magnet part 130 and the electromagnet part 150 may repeatedly change in the circumferential direction. That is, each of the plurality of electromagnets 153 may have both circumferential ends thereof tapered so that a circumferential central portion thereof protrudes upwardly in the axial direction, i.e., toward the magnet part 130. Also, each of the plurality of electromagnets 153 may be rounded in the circumferential direction so that the circumferential central portion thereof protrudes upwardly in the axial direction, i.e., toward the magnet part 130.

The electromagnet part 150 may include the plurality of electromagnets 153 disposed in the circumferential direction. Here, each of the electromagnets 153 may include a core 151 and a coil 152 wound around the core 151. Also, an axial upper end of the core 151 may face the magnet part 130.

Furthermore, although not shown, the electromagnet part 150 may not include the core 151. That is, a coil part wound by using a separate winding machine, i.e., a winding coil may be repeatedly disposed on an axial upper portion of the support member 140 in the circumferential direction. Also, in this case, an axial distance between facing surfaces of the coil part and the magnet part 130 may repeatedly change in the circumferential direction. That is, the coil part may be tapered or rounded.

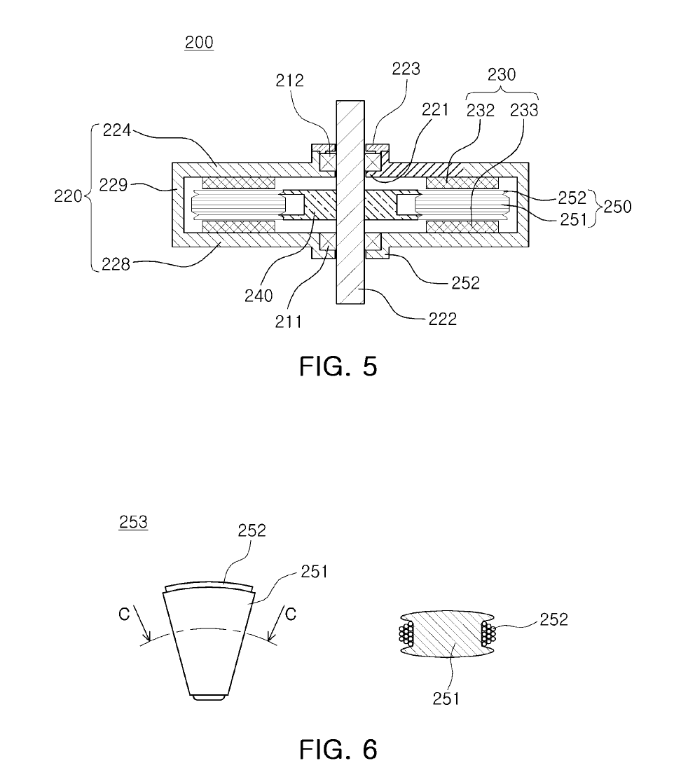

FIG. 5 is a cross-sectional view of an axial flux permanent magnet motor according to another embodiment of the present invention. FIG. 6 is a plan view of an electromagnet constituting an electromagnet part and a cross-sectional view of the electromagnet in a circumferential direction according to another embodiment of the present invention. Also, the current embodiment will be described with reference to FIGS. 2 and 4.

Referring to FIG. 5, an axial flux permanent magnet motor 200 according to another embodiment of the present invention may include a shaft 210, a rotor 220, a magnet part 230, a support member 240, and an electromagnet part 250.

Here, terms with respect to directions will be defined. As shown in FIG. 5, an axial direction refers to a vertical direction, i.e., a direction upwardly from a lower portion of the shaft 210 or a direction downward from an upper portion of the shaft 210, and a radius direction refers to a horizontal direction, i.e., a direction toward an outer end of the rotor 220 from the shaft 210 or a direction toward the shaft 210 from the outer end of the rotor 220. Also, a circumferential direction refers to a direction rotating along a predetermined radius with respect to a rotation center. For example, the circumferential direction may represent a direction rotating along the outer end of the rotor 220.

In the axial flux permanent magnet motor 200 according to another embodiment of the present invention, a rotor member may relatively rotate with respect to a stator member by using the magnet part 230 and the electromagnet part 250 which are disposed to face each other in an axial direction. In this case, the rotor member may smoothly rotate with respect to the stator member by configurations of the magnet part 230 and the electromagnet part 250.

Here, the rotor member may be a member that rotates relatively with respect to the stator member. Also, the rotor member may include the rotor 220 and the magnet part 230.

Furthermore, the stator member may be a member that is relatively fixed to the rotor member. Also, the stator member may include the shaft 210, the support member 240, and the electromagnet part 250.

The shaft 210 may be a member having a bar shape, disposed in the axial direction. The shaft 210 may have a round pillar shape so that a member mounted on the shaft 210 may easily rotate.

Lower and upper bearing parts 211 and 212 may be disposed on an outer circumferential surface of the shaft 211. In the current embodiment, since the rotor 220 includes a first extension member 225 and a second extension member 228, the lower and upper bearing parts 211 and 212 may be disposed on the shaft 210 so that the lower and upper bearing parts 211 and 212 are spaced apart from each other by a predetermined distance in the axial direction.

Each of the lower and upper bearing parts 211 and 212 may be disposed on a portion at which a radial inner end of the rotor 220 is mounted on the shaft 210 so that the rotor 220 mounted on the shaft 210 rotates smoothly. The bearing part 211 may fix a rotating shaft of the rotor 220 in a predetermined position, i.e., the shaft 210. In addition, the bearing part 211 may allow the shaft of the rotor 220 rotate while supporting a self-weight of the shaft of the rotor 220 and a load applied to the shaft of the rotor 220. A sliding bearing or a rolling bearing may be used as the bearing part 111. For example, the sliding bearing may be lubricating oil disposed between the shaft 210 and the rotor 220. Also, the rolling bearing may be a ball bearing provided on the shaft 210. Hereinafter, the ball bearing will be described as one example of the bearing part 211.

The rotor 220 may be rotatably coupled to the shaft 210. That is, the rotor 220 may be coupled to the shaft 210 so that the rotor 120 rotates smoothly by using the bearing part 211 disposed on the shaft 210 as a medium. That is, the rotor 220 may extend outwardly from the shaft 110 in the radial direction. Also, the rotor 120 may be rotatably mounted on the shaft 210. Particularly, the rotor 220 may include the pair of first and second extension members 224 and 228 which are spaced apart from each other by a predetermined distance in the axial direction to extend in the radial direction.

In more detail, an upper bearing fixing part 221 may be disposed on a radial inner end of the first extension member 225, and a lower bearing fixing part 222 may be disposed on a radial inner end of the second extension member 228. The upper and lower bearing fixing parts 221 and 222 may have shapes to accommodate the upper and lower bearing parts 212 and 211 disposed on a radial outer surface of the shaft 210, respectively.

That is, the upper bearing fixing part 221 may be securely fixed by covering a fixing cap 223 on an upper portion thereof in the state in which the upper bearing fixing part 121 accommodates the upper bearing part 212 therein. The fixing cap 223 may be fixed to the upper bearing fixing part 221 through an inter-member coupling member formed by a method such as press fitting, bonding using an adhesive, welding, and the like.

The first and second extension members 224 and 228 may be connected to each other at radial outer ends thereof by a connection member 229. Thus, the first and second extension members 224 and 228 may rotate together.

The magnet part 230 may be disposed on the rotor 220. In more detail, the magnet part 230 may be disposed on the first and second extension members 224 and 228 to face each other in the axial direction. That is, a first magnet part 232 may be disposed on an axial lower surface of the first extension member 224, and a second magnet part 233 may be disposed on an axial upper surface of the second extension member 228.

That is, the first and second magnet parts 232 and 233 may be disposed on the first and second extension members 224 and 228 to face each other in the axial direction, respectively. Here, N poles and S poles of each of the first and second magnet parts 232 and 233 may be alternately disposed in a circumferential direction. Also, each of the first and second magnet parts 232 and 233 may include a plurality of magnets 231 in the circumferential direction. That is, each of the first and second magnet parts 232 and 233 constituting the magnet part 230 may include the plurality of magnets 231 in which the N poles and the S poles are alternately disposed in the circumferential direction.

The electromagnet part 250 may be disposed between the first magnet part 232 and the second magnet part 233 to face all of the first and second magnet parts 232 and 233 in the axial direction.

Here, an axial distance between facing surfaces of the first magnet part 232 and the electromagnet part 250 and an axial distance between facing surfaces of the second magnet part 233 and the electromagnet part 250 may repeatedly change in the circumferential direction. That is, each of the plurality of magnets 231 constituting the first and second magnet parts 232 and 233 may have both circumferential ends thereof tapered so that a circumferential central portion thereof protrudes toward the electromagnet part 250 in the axial direction. Also, each of the plurality of magnets 231 constituting the first and second magnet parts 232 and 233 may be rounded in the circumferential direction so that the circumferential central portion thereof protrudes toward the electromagnet part 250 in the axial direction.

The support member 240 may extend outward from the shaft 210 in the radial direction. Also, the support member 240 may be disposed between the first and second extension members 224 and 228. The electromagnet part 250 may be disposed so that an axial upper surface of a radial outer end of the support member 240 faces the first magnet part 232, and an axial lower surface faces the second magnet part 233.

The electromagnet part 250 may be disposed on an end of the support member 240. In more detail, the electromagnet part 250 may be disposed on the support member 140 so that the axial upper surface thereof faces the first magnet part 232, and the axial lower surface thereof faces the second magnet part 233. That is, the electromagnet part 250 may be disposed in the circumferential direction to face all of the first and second magnet parts 232 and 233. Also, each of the first and second magnet parts 232 and 233 constituting the electromagnet part 250 may include a plurality of electromagnets 253 in the circumferential direction.

Here, an axial distance between the facing surfaces of the first and second magnet parts 232 and 233 and the electromagnet part 250 may repeatedly change in the circumferential direction. That is, each of the plurality of electromagnets 253 may have both circumferential ends thereof tapered so that a circumferential central portion thereof protrudes toward the magnet part in the axial direction. That is, each of the electromagnets 253 constituting the electromagnet part 250 may have the axial upper and lower surfaces of which both circumferential ends are tapered.

That is, each of the plurality of electromagnets 253 may be rounded in the circumferential direction so that the circumferential central portion thereof protrudes toward the first and second magnet parts 232 and 233 in the axial direction. That is, each of the electromagnets 253 constituting the electromagnet part 250 may have the axial upper and lower surfaces which are respectively rounded in the axial direction.

The electromagnet part 250 may include the plurality of electromagnets 253 disposed in the circumferential direction. Here, each of the electromagnets 253 may include a core 251 and a coil 252 wound around the core 151. Here, axial upper and lower surfaces of the core 251 may face the first and second magnet parts 232 and 233, respectively.

Furthermore, although not shown, the electromagnet part 250 may not include the core 251. That is, a coil part wound by using a separate winding machine, i.e., a winding coil may be repeatedly disposed on an axial outer end of the support member 240 in the circumferential direction. Also, in this case, an axial distance between facing surfaces of the coil part and the first and second magnet parts 232 and 233 may repeatedly change in the circumferential direction. That is, the coil part may be tapered or rounded.

In the above-described embodiments, although all of the first and second magnet parts 232 and 233 are tapered or rounded at the portions facing the electromagnet part 250, and all of the axial upper and lower surfaces of the electromagnet part 250 facing the first and second magnet parts 232 and 233 may be tapered or rounded, the present invention is not limited thereto. That is, the first magnet part 232 may be tapered or rounded at the facing portions of the first magnet part 232 and the electromagnet part 250, and the electromagnet part 250 may be tapered or rounded at the facing portions of the second magnet part 233 and the electromagnet part 250, and converse.

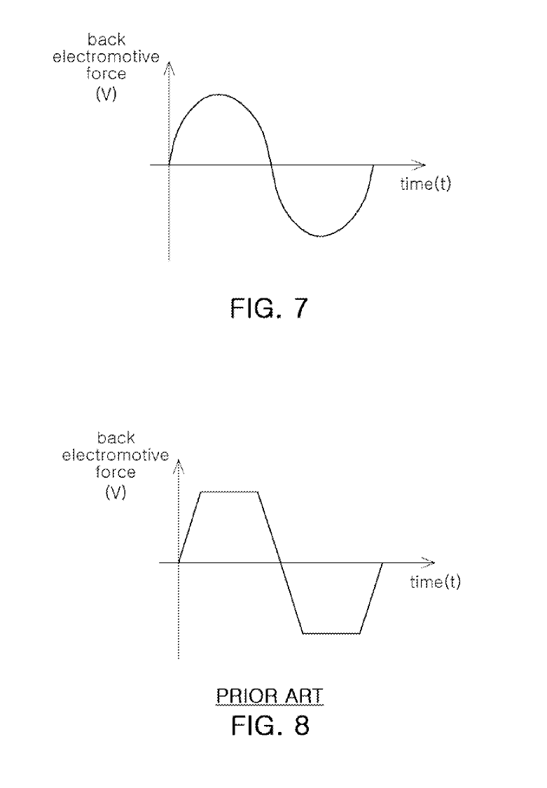

FIG. 7 is a graph illustrating back electromotive force occurring when the axial flux permanent magnet motor operates according to the present invention.

In the axial flux permanent magnet motors 100 and 200 according to the embodiments of the present invention, since a distance between the facing portions of the magnet part and the electromagnet part may grow and narrow, the back electromotive force curve as shown in FIG. 7 may be derived when the motors 100 and 200 are driven. That is, each of the motors 100 and 200 may smoothly rotate.

According to the present invention, when the rotor member rotates relatively with respect to the stator member, the rotor member may smoothly rotate with respect to a stator member.

Also, according to the present invention, axial flux permanent magnet motor may simply changes in configuration to solve the above-described limitations.

While the present invention has been shown and described in connection with the embodiments, it will be apparent to those skilled in the art that modifications and variations can be made without departing from the spirit and scope of the invention as defined by the appended claims.

What is claimed is:

1. An axial flux permanent magnet motor comprising:
a shaft;
a rotor extending from the shaft in a radial direction, the rotor being rotatably mounted on the shaft;
a magnet part disposed on the rotor to face downwardly in an axial direction, the magnet part having N poles and S poles, alternately disposed in a circumferential direction;
a support member extending from the shaft in a radial direction, the support member being disposed below the rotor in the axial direction; and
an electromagnet part disposed on the support member to face the magnet part in the axial direction,
wherein an axial distance between facing surfaces of the magnet part and the electromagnet part repeatedly changes in the circumferential direction.

2. The axial flux permanent magnet motor of claim 1, wherein the magnet part comprises a plurality of magnets provided in the circumferential direction, and
each of the plurality of magnets comprises both circumferential ends thereof tapered so that a circumferential central portion thereof protrudes downwardly in the axial direction.

3. The axial flux permanent magnet motor of claim 1, wherein the magnet part comprises a plurality of magnets provided in the circumferential direction, and
each of the plurality of magnets is rounded in the circumferential direction so that a circumferential central portion thereof protrudes downwardly in the axial direction.

4. The axial flux permanent magnet motor of claim 1, wherein the electromagnet part comprises a plurality of electromagnets provided in the circumferential direction, and
each of the plurality of electromagnets comprises both circumferential ends thereof tapered so that a circumferential central portion thereof protrudes upwardly in the axial direction.

5. The axial flux permanent magnet motor of claim 1, wherein the electromagnet part comprises a plurality of electromagnets provided in the circumferential direction, and
each of the plurality of electromagnets is rounded in the circumferential so that a circumferential central portion thereof protrudes upwardly in the axial direction.

6. The axial flux permanent magnet motor of claim 1, wherein the electromagnet part comprises a plurality of electromagnets disposed in the circumferential direction,
wherein each of the plurality of electromagnets comprises a core and a coil wound around the core,
wherein an axial upper end of the core faces the magnet part.

7. The axial flux permanent magnet motor of claim 1, wherein the winding coil of the electromagnet part is repeatedly disposed in the circumferential direction.

8. An axial flux permanent magnet motor comprising:
a shaft;
a rotor spaced apart from the shaft in an axial direction by a predetermined distance and comprising a pair of first and second extension members extending in a radial direction, the rotor being rotatably mounted on the shaft;
first and second magnet parts respectively disposed on the first and second extension members to face each other in the axial direction, the first and second magnet parts having N poles and S poles, alternately disposed in a circumferential direction;
a support member extending from the shaft in the radial direction, the support member being disposed between the first and second extension members in the axial direction; and
an electromagnet part disposed on the support member to face the first and second magnet parts in the axial direction,
wherein an axial distance between facing surfaces of the first and second magnet parts and the electromagnet part repeatedly changes in the circumferential direction.

9. The axial flux permanent magnet motor of claim 8, wherein the first and second extension members are connected to each other at radial outer ends thereof.

10. The axial flux permanent magnet motor of claim 8, wherein each of the first and second magnet parts comprises a plurality of magnets, and
each of the plurality of magnets comprises both circumferential ends thereof tapered so that a circumferential central portion thereof protrudes toward the electromagnet in the axial direction.

11. The axial flux permanent magnet motor of claim 8, wherein each of the first and second magnet parts comprises a plurality of magnets, and
each of the plurality of magnets is rounded in the circumferential direction so that a circumferential central portion thereof protrudes toward the electromagnet in the axial direction.

12. The axial flux permanent magnet motor of claim 8, wherein the electromagnet part comprises a plurality of electromagnets provided in the circumferential direction, and
each of the plurality of electromagnets comprises both circumferential ends thereof tapered so that a circumferential central portion thereof protrudes toward the first and second magnet parts in the axial direction.

13. The axial flux permanent magnet motor of claim 8, wherein the electromagnet part comprises a plurality of electromagnets provided in the circumferential direction, and
each of the plurality of electromagnets is rounded in the circumferential direction so that a circumferential central portion thereof protrudes toward the first and second magnet parts in the axial direction.

14. The axial flux permanent magnet motor of claim 8, wherein the first magnet part comprises a plurality of magnets provided in the circumferential direction, and
each of the plurality of magnets is rounded in the circumferential direction so that a circumferential central portion thereof protrudes toward the electromagnet part in the axial direction.

15. The axial flux permanent magnet motor of claim 8, wherein the electromagnet part comprises a plurality of electromagnets provided in the circumferential direction, and
each of the plurality of electromagnets is rounded in the circumferential direction so that a circumferential central portion thereof protrudes toward the second magnet part in the axial direction.

16. The axial flux permanent magnet motor of claim 8, wherein the electromagnet part comprises a plurality of electromagnets disposed in the circumferential direction,
wherein each of the plurality of electromagnets comprises a core and a coil wound around the core,
wherein axial upper and lower ends of the core face the first and second magnet parts, respectively.

17. The axial flux permanent magnet motor of claim 8, wherein the winding coil of the electromagnet part is repeatedly disposed in the circumferential direction.

18. An axial flux permanent magnet motor comprising:
a stator member;
a rotor member rotatably mounted on the stator member;
a magnet part disposed on the rotor member to face an axial direction, the magnet part having N poles and S poles, alternately disposed in a circumferential direction; and
an electromagnet part disposed on the stator member to face the magnet part in the axial direction,
wherein an axial distance between facing surfaces of the magnet part and the electromagnet part repeatedly changes in the circumferential direction.
